(19) United States
(12) Patent Application Publication
(10) Pub. No.: US 2017/0058952 A1
(43) Pub. Date: Mar. 2, 2017

(54) ROCKER SUPPORT BOLT BUSHING

(71) Applicant: John P. Lindsay, Brentwood, CA (US)

(72) Inventor: John P. Lindsay, Brentwood, CA (US)

(21) Appl. No.: 15/225,596

(22) Filed: Aug. 1, 2016

Related U.S. Application Data
(60) Provisional application No. 62/200,017, filed on Aug. 1, 2015.
(60) Provisional application No. 62/284,859, filed on Oct. 13, 2015.
(60) Provisional application No. 62/272,070, filed on Feb. 22, 2016.
(60) Provisional application No. 62/275,210, filed on Jan. 5, 2016.
(60) Provisional application No. 62/276,821, filed on Jan. 8, 2016.
(60) Provisional application No. 62/276,866, filed on Jan. 10, 2016.
(60) Provisional application No. 62/278,413, filed on Jan. 13, 2016.
(60) Provisional application No. 62/310,791, filed on Mar. 20, 2016.
(60) Provisional application No. 62/358,031, filed on Jul. 3, 2016.

(51) Int. Cl. F16C 33/04; F01L 1/18

(52) U.S. Cl. CPC F16C 33/04; F01L 1/18; F01L 2810/04

(57) ABSTRACT

A bushing for taking up the gap between a support bolt and a rocker arm shaft in an internal combustion engine in order to eliminate unwanted motion and subsequent engine noise.

### CROSS REFERENCE TO RELATED APPLICATIONS

This Application claims priority under 35 U.S.C. §119(e) from earlier filed U.S. Provisional Applications Ser. No. 62/200017, filed Aug. 1, 2015; Ser. No. 62/284859, filed Oct. 13, 2015; Ser. No. 62/272070, filed Dec. 29, 2015, Ser. No. 62/275210, filed Jan. 5, 2016; Ser. No. 62/276821, filed Jan. 8, 2015; 62/276866, filed Jan. 10, 2016; Ser. No. 62/278413, filed Jan. 13, 2016; Ser. No. 62/310791, filed Mar. 20, 2016; Ser. No. 62/358031, filed Jul. 3, 2016. The entirety of all the above-listed provisional applications are incorporated herein by reference.

### BACKGROUND

Technical Field

The present device is in the field of internal combustion engines, particularly the valve train components of such engines.

Summary

In a typical motorcycle engine, for example, the rocker assembly includes a rocker arm support that holds a rocker arm shaft. A rocker support bolt secures the rocker arm support and also cross-pins the rocker arm shaft in place. However, in some engines, there can be excessive clearance between the rocker support bolt and the rocker arm shaft. This can cause a loud tapping noise at higher rpms.

A round bushing placed on the rocker support bolt can take up this space and eliminate the tapping caused by the rocker arm shaft hitting the bolt. However, some bushings can be compressed and deformed during installation rather than push down into the hole. Although bushings made of more malleable materials can have the advantage of compressing during installation and then restoring to a relaxed state to expand and fill the space, they, too, can be subject to undesirable deformation on installation. Further the rocker support plate can have a casting parting ring around the circumference of the hole, which can increase the flaring problem. This can lead to problems of alignment and valve train geometry.

Substantially cylindrical bushings can address this issue, but must be precisely machined to fit both bolts and rocker plate holes, which can be expensive to produce. Non-cylindrical bushings, though, can fit a wide variety of bolt/plate combinations. What is needed is an improved bushing for a rocker support bolt to properly align and lock the rocker arm shaft, that is easy to install and can fill the clearance space while withstanding temperatures of engine operation

### BRIEF DESCRIPTION OF THE DRAWINGS

Further details of the present device are explained with the help of the attached drawings in which:

FIG. 1a depicts an exploded perspective view of a rocker arm support assembly of a typical engine.

FIG. 1b depicts an exploded side view of the rocker arm support assembly shown in FIG. 1a.

FIG. 1c depicts a detail cutaway side view of the support bolt insertion point on the rocker arm support assembly shown in FIG. 1a.

FIG. 2a depicts a perspective view of one embodiment of the present device.

FIG. 2b depicts a perspective view of an alternate embodiment of the present device as shown in FIG. 2a.

FIG. 3a depicts a perspective view of one embodiment of the present device.

FIG. 3b depicts a perspective view of an alternate embodiment of the present device as shown in FIG. 3a.

FIG. 4a depicts a perspective view of one embodiment of the present device.

FIG. 4b depicts a perspective view of an alternate embodiment of the present device shown in FIG. 4a.

FIG. 5a depicts a perspective view of one embodiment of the present device.

FIG. 5b depicts a perspective view of an alternate embodiment of the present device shown in FIG. 5a.

FIG. 6a depicts a perspective view of one embodiment of the present device.

FIG. 6b depicts a perspective view of an alternate embodiment of the present device shown in FIG. 6a.

FIG. 7a depicts a perspective view of one embodiment of the present device.

FIG. 7b depicts a perspective view of an alternate embodiment of the present device shown in FIG. 7a.

FIG. 8a depicts a perspective view of one embodiment of the present device.

FIG. 8b depicts a perspective view of an alternate embodiment of the present device shown in FIG. 8a.

FIG. 9a depicts a perspective view of one embodiment of the present device.

FIG. 9b depicts a perspective view of an alternate embodiment of the present device shown in FIG. 9a.

FIG. 10a depicts a perspective view of one embodiment of the present device.

FIG. 10b depicts a perspective view of an alternate embodiment of the present device shown in FIG. 10a.

### DETAILED DESCRIPTION

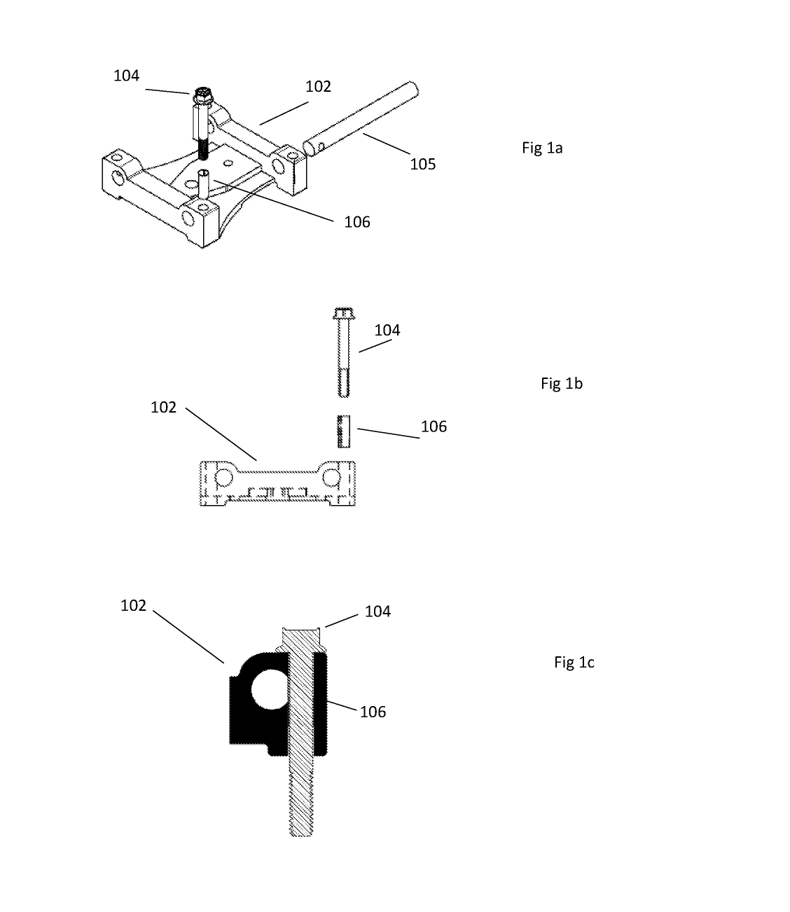

FIG. 1a depicts an exploded perspective view of a rocker arm support assembly of an engine. A rocker arm support 102 can have a plurality of bolts 104 securing a rocker arm support 102 and a rocker arm shaft 105. As shown in FIG. 1a, some embodiments of the present device can be a bushing 106 having an inner surface and an outer surface, and a distal end and a proximal end. In some embodiments the inner diameter of a bushing 106 can be such to selectively engage longitudinally with a bolt 104 passing through it, but in other embodiments can be any other known and/or convenient diameter. In the embodiment shown in FIG. 1a, a bushing 106 can be substantially cylindrical, or have a substantially longitudinally constant outer diameter, but in other embodiments can have a longitudinally varying outer diameter. In some embodiments a bushing 106 can be fabricated from steel or any other known and/or convenient material, and can be hardened, spring-tempered, or subject to any other known and/or convenient process. In some embodiments, a spring-tempered material can be advantageous to maintain device performance during heat expansion.

FIG. 1b depicts an exploded side view of the rocker arm support assembly shown in FIG. 1a. In some embodiments, a bolt 104 can pass through a bushing 106, where they can selectively engage into a designated hole in a rocker arm support 102.

FIG. 1c depicts a detail cutaway side view of the support bolt insertion point on the rocker arm support assembly shown in FIG. 1 a. As a bolt 104 engages with a rocker arm support 102, a bolt 104 can also align with a notch in a rocker arm shaft 105, locking it in place. In some embodiments, a bushing 106 can occupy the clearance space between a bolt 104, a rocker arm support 102, and a rocker arm shaft 105, thereby tightening the fit.

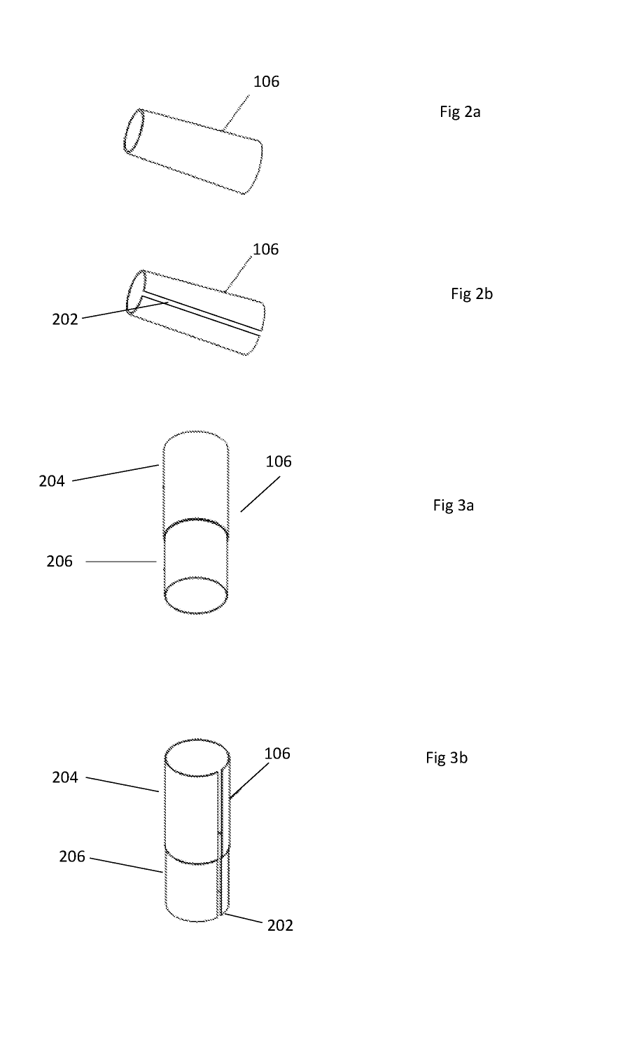

In the embodiment shown in FIG. 2a, a bushing 106 can have sections of longitudinally varying outer diameter. In some embodiments, the distal end of a bushing 106 can have an outer diameter less than that of the proximal end. As shown in FIG. 2a, a bushing 106 can have a tapered geometry, but in other embodiments can have any other known and/or convenient geometry.

FIG. 2b depicts an alternate embodiment of the present device as shown in FIG. 2a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

FIG. 3a depicts another embodiment of the present device in which a bushing 106 can have sections of longitudinally varying diameter. In the embodiment of FIG. 3a, a bushing 106 can have a first segment 204 with a larger diameter than that of at least one second segment 206. In some embodiments, a first segment 204 can be located at the proximal end of a bushing 106, with at least one second segment 206 at the distal end, but can have any other known and/or convenient configuration in other embodiments.

FIG. 3b depicts an alternate embodiment of the present device as shown in FIG. 3a, in which a bushing 106 can have a longitudinal slit 202. In some embodiments a longitudinal slit 202 can run along the entire length of a bushing 106, but in other embodiments can run longitudinally along any known and/or convenient segment of a bushing 106. In the embodiment shown in FIG. 3b, fabricating a bushing 106 from a spring-tempered material can improve device performance by allowing a bushing 106 to maintain pressure against a rocker arm shaft 105 even as a rocker assembly expands due to heat.

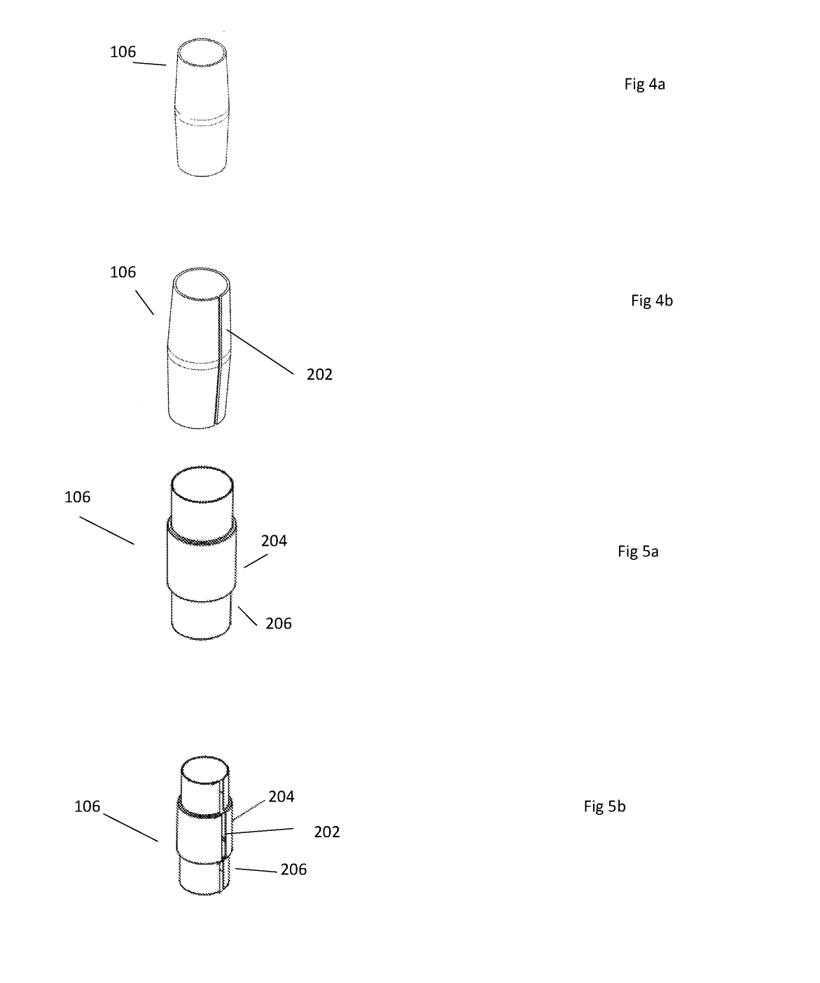

FIG. 4a depicts a perspective view of another embodiment of the present device, in which a bushing 106 can have sections of longitudinally varying outer diameter. In some embodiments, the distal end and the proximal end of a bushing 106 can each have an outer diameter less than that of a region substantially at the longitudinal midpoint of a bushing 106. As shown in FIG. 4a, a bushing 106 can have a double-tapered geometry substantially symmetric about the longitudinal midpoint of a bushing 106, but in other embodiments can have any other known and/or convenient geometry.

FIG. 4b depicts an alternate embodiment of the present device as shown in FIG. 4a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

FIG. 5a depicts another embodiment of the present device in which a bushing 106 can have sections of longitudinally varying diameter. In the embodiment of FIG. 5a, a bushing 106 can have a first segment 204 with a larger diameter than that of at least one second segment 206. In some embodiments, a first segment 204 can be located substantially at the longitudinal midpoint of a bushing 106, with a second segments 206 of at the proximal and the distal end, but can have any other known and/or convenient configuration in other embodiments. In some embodiments, second segments 206 can be of substantially equal length, but in other embodiments can be of any other known and/or convenient lengths.

FIG. 5b depicts an alternate embodiment of the present device as shown in FIG. 5a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

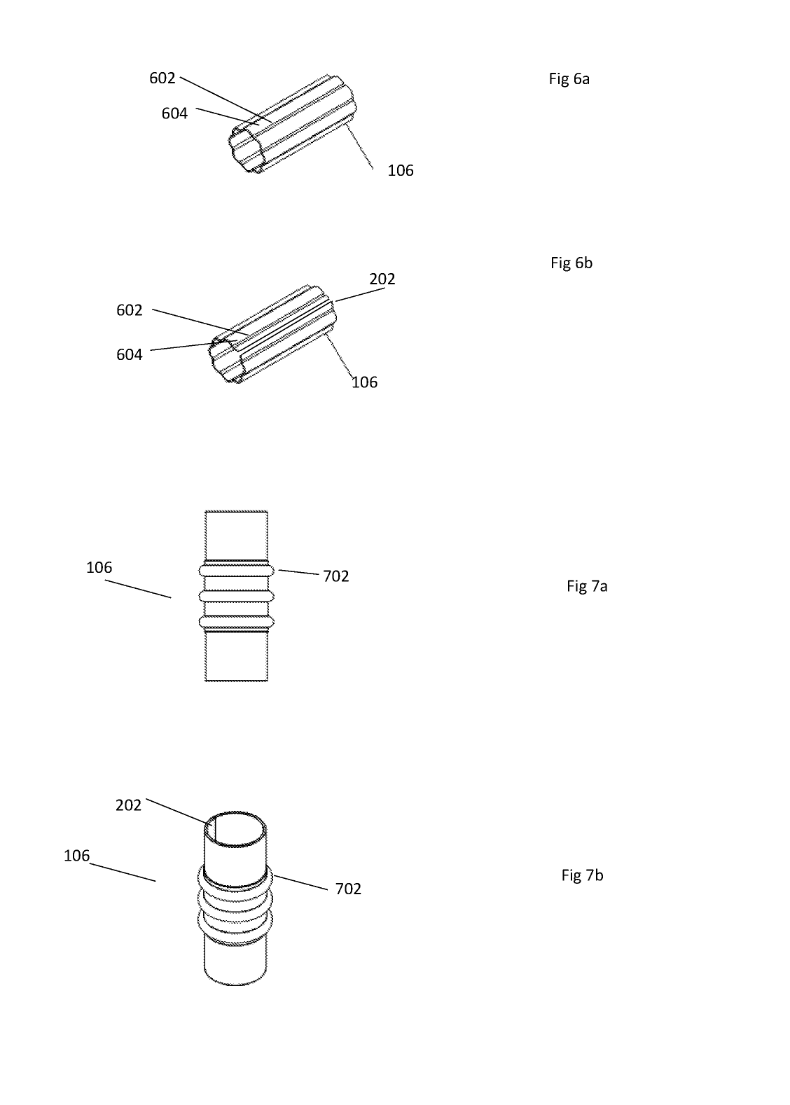

FIG. 6a depicts a perspective view of another embodiment of the present device. In some embodiments, a bushing 106 can have a non-circular cross section with a plurality of longitudinal grooves 602 adjacent to longitudinal ridges 604. As shown in FIG. 6a, longitudinal grooves 602 and longitudinal ridges 604 can have a rounded cross sections, but in other embodiments can have any other known and/or convenient cross-sectional geometry.

FIG. 6b depicts an alternate embodiment of the present device as shown in FIG. 6a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

As shown in FIG. 7a, other embodiments of the present device can have at least one portion of the outer surface extruded to form at least one circumferential ridge 702, which can be located substantially at the longitudinal midpoint of a bushing 106. However, circumferential ridges 702 can be located at any other known and/or convenient point on the outer surface of a bushing 106. In the embodiment of FIG. 7a, circumferential ridges 702 can have a rounded cross-section, but in other embodiments can have any other known and/or convenient cross-sectional geometry.

FIG. 7b depicts an alternate embodiment of the present device as shown in FIG. 7a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

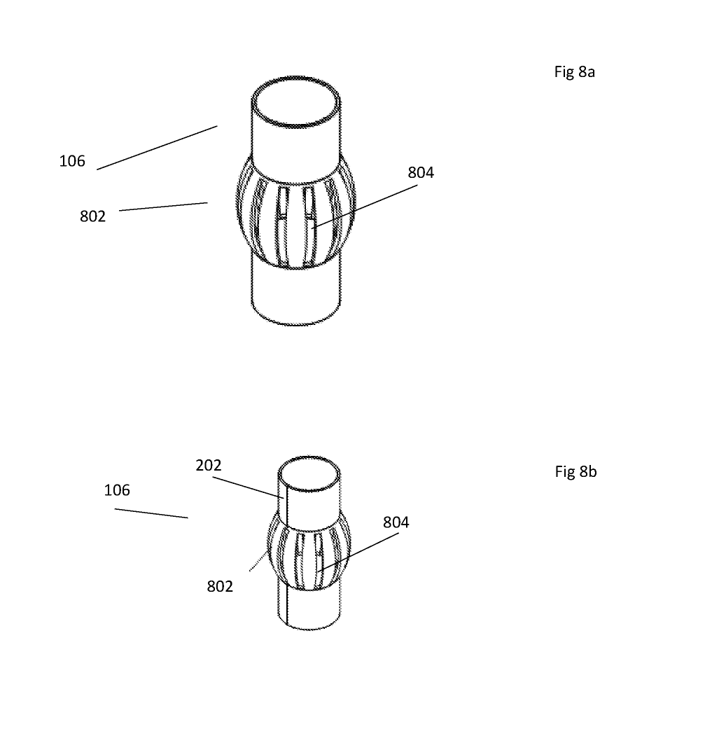

FIG. 8a depicts another embodiment of the present device. As shown in FIG. 8a, a bushing 106 can have a segment 802 with a plurality of longitudinal slots 804. In some embodiments, a segment 802 can be extruded radially such that the surfaces of a bushing 106 radially adjacent to longitudinal slots 804 bulge outward. As shown in FIG. 8a, a segment 802 can have a bulbous configuration, but in other embodiments can have any other known and/or convenient geometry.

FIG. 8b depicts an alternate embodiment of the present device as shown in FIG. 8a, in which a bushing 106 can have a longitudinal slit 202. In some embodiments a longitudinal slit 202 can run along the entire length of a bushing 106, but in other embodiments can run longitudinally along any known and/or convenient segment of a bushing 106.

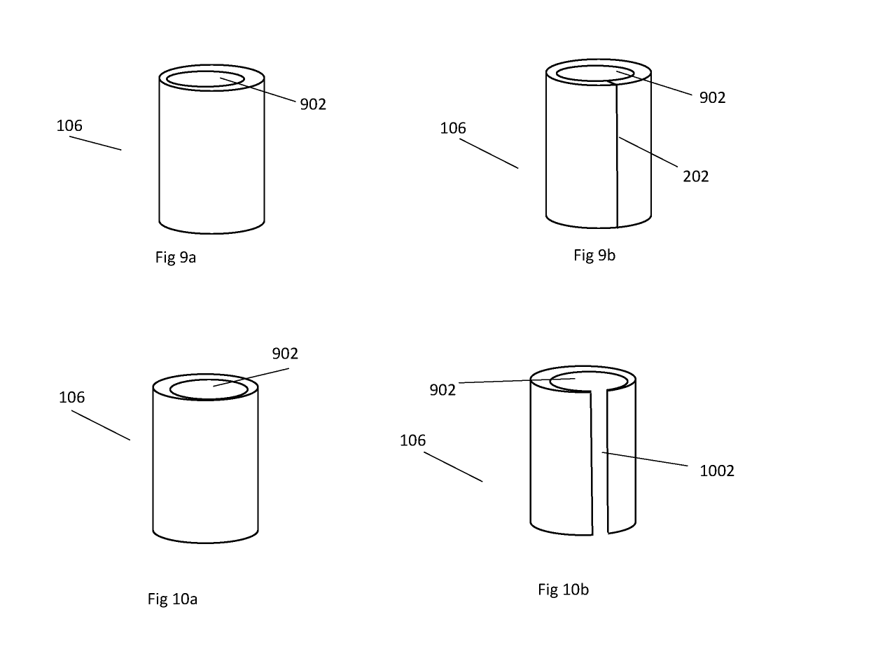

FIG. 9a depicts another embodiment of the present device, in which a bushing 106 can have a circumferentially varying wall thickness. In such embodiments, the inner surface of a bushing 106 does not substantially align with the outer surface relative to the central longitudinal axis of a bushing 106. An opening 902 can be non-concentric with the outer surface of a bushing 106.

FIG. 9b depicts an alternate embodiment of the present device as shown in FIG. 9, in which a bushing 106 can have a longitudinal slit 202. In some embodiments a longitudinal slit 202 can run along the entire length of a bushing 106, but in other embodiments can run longitudinally along any known and/or convenient segment of a bushing 106.

FIG. 10a depicts another embodiment of the present device, in which a bushing 106 can have a circumferentially varying wall thickness. In such embodiments, the inner surface of a bushing 106 does not substantially align with the outer surface relative to the central longitudinal axis of a bushing 106. An opening 902 can be non-concentric with the outer surface of a bushing 106. As shown in FIG. 10a, this configuration can create a bushing 106 with a crescent-shaped cross-section.

FIG. 10b depicts an alternate embodiment of the present device as shown in FIG. 10a, in which a bushing 106 having a crescent-shaped cross section can have a longitudinal gap 1002. In some embodiments a longitudinal gap 1002 can run along the entire length of a bushing 106, but in other embodiments can run longitudinally along any known and/or convenient segment of a bushing 106. A longitudinal gap 1002 can be located at the point of least thickness of the cross-section or at any other known and/or convenient location.

In use, a bushing 106 can be placed into a hole on a rocker arm support 102. A bolt 104 can be placed through a bushing 106 and then through a rocker arm support 102. Tightening down a bolt 104 can push a bushing 106 down into the hole, filling the clearance space between a bolt 104 and a rocker arm shaft 105. This can mitigate or eliminate the motion of a rocker arm shaft 105 against a bolt and the tapping sound that creates. In some embodiments, the present device can also dampen the sound of closing valves in the engine and decrease unwanted noise.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the claims.

What is claimed:

1. A bushing having a proximal end and a distal end, an inner surface and an outer surface, and an inner diameter and an outer diameter,
wherein the outer diameter varies longitudinally.

2. The bushing of claim 1, wherein the outer diameter of the proximal end is larger than the outer diameter of the distal end.

3. The bushing of claim 2, wherein the outer surface continuously tapers from the proximal end to the distal end.

4. The bushing of claim 3, further comprising a longitudinal slit along the length of said bushing.

5. The bushing of claim 2, further comprising a first segment at the proximal end and a second segment at the distal end,
wherein the outer diameter of the first segment is greater than the outer diameter of the second segment.

6. The bushing of claim 5, further comprising a longitudinal slit along the length of said bushing.

7. A bushing having a proximal end and a distal end, an inner surface and an outer surface, and an inner diameter and an outer diameter,
wherein at least one segment of the outer surface is extruded.

8. The bushing of claim 7, wherein at least one segment is extruded to form a circumferential ridge.

9. The bushing of claim 8, further comprising a longitudinal slit along the length of said bushing.

10. The bushing of claim 7, wherein a plurality of longitudinal ridges are radially extruded.

11. The bushing of claim 10, further comprising a longitudinal slit along the length of said bushing.

12. The bushing of claim 7, further comprising a segment containing a plurality of longitudinal slots, wherein the surface of the bushing between said slots is radially extruded to form a substantially bulbous geometry.

13. The bushing of claim 12, further comprising a longitudinal slit along the length of said bushing.

14. A bushing having a circumferentially varying wall thickness and a crescent-shaped cross section.

15. The bushing of claim 14, further comprising a longitudinal gap along the length of said bushing at the point of least thickness.
